(19) United States
(12) Patent Application Publication
(10) Pub. No.: US 2005/0071802 A1
(43) Pub. Date: Mar. 31, 2005

(54) Numerical control with machine-tool simulator

(76) Inventors: Michael Brakelmann, Wedemark (DE); Mathias Eugster, Winterthur (CH)

Correspondence Address: KENYON & KENYON, ONE BROADWAY, NEW YORK, NY, 10004, US

(21) Appl. No.: 10/952,598

(22) Filed: Sep. 29, 2004

(30) Foreign Application Priority Data
Sep. 29, 2003 (DE) 103 45 626.0

(51) Int. Cl. G06F 9/44; G05B 19/42; G06G 7/48

(52) U.S. Cl. 717/100; 703/6; 700/87

(57) ABSTRACT

In a numerical control with a machine-tool simulator, a special device is provided for the exchange of information between the numerical control or an allocated PLC and the machine-tool simulator. This device includes a jointly utilized memory, via which information is able to be exchanged between the numerical control and the machine-tool simulator, the jointly utilized memory being writeable and readable both by the numerical control and by the machine-tool simulator.

### CROSS-REFERENCE TO RELATED APPLICATIONS

The present application claims priority to Application No. 103 45 626.0, filed in the Federal Republic of Germany on Sep. 29, 2003, which is expressly incorporated herein in its entirety by reference thereto.

### FIELD OF THE INVENTION

The present invention relates to a numerical control with machine-tool simulator. Such a combination of numerical control and machine-tool simulator may be used to markedly shorten the start-up time of a machine tool having an allocated numerical control.

### BACKGROUND INFORMATION

Machine tools having an allocated numerical control are playing an increasingly more important role in the field of automated production of geometrically exacting machined parts. The complexity of the machine tools themselves, as well as that of the numerical controls is constantly increasing. Thus, for example, the number of movable axes and the possible processing speed of current machine tools is increasing in the same manner as, for example, the operating comfort or the number of safety-directed functions of the most modern numerical controls.

A manufacturer of machine tools may purchase suitable numerical controls from an external supplier. Before a new combination of machine tool and numerical control is delivered, the numerical control may be adapted to the machine tool.

This may be accomplished by a programmable logic controller which is assigned to the numerical control and which in the following is called PLC for short, as may be conventional in the industry. Such a PLC makes available a multitude of inputs and outputs. Using a PLC program, it is possible to establish how the outputs of the PLC react to the inputs. Thus, it is possible to establish, for example, that an enable signal for the movement of the machine-tool axes is present at the output only in response to a closed door contact at the input of the PLC. This may prevent the movement of a tool if the door to the working area of the machine tool is open and may represent an important safety function during normal operation of a machine tool.

It is usually necessary to test the PLC program on a real machine tool. Since it is often necessary to do this in a machine room in a noisy environment not conducive to concentration, there is believed to have existed a demand for possibilities to develop and test PLC programs on a virtual, merely simulated machine tool.

A machine-tool simulator is described, for example, in Japanese Published Patent Application No. 2001282331. The machine-tool simulator is connected to the numerical control and the assigned PLC via an interface. A processor processes the information received via the interface and simulates the behavior of a virtual machine tool. Even though testing of PLC programs is simplified, the possibilities for testing and developing PLC programs are not yet believed to be optimal. Moreover, it is necessary to make further devices (e.g., computers) available in addition to the numerical control.

### SUMMARY

According to an example embodiment of the present invention, a numerical control with a machine-tool simulator is provided which, in cooperation, may offer an optimal support in the development and testing of PLC programs for adapting a numerical control to a machine tool.

In an example embodiment of the present invention, a numerical control with a machine-tool simulator is provided, in which the numerical control is provided with a device for the exchange of information between the numerical control or an allocated PLC and the machine-tool simulator. This device includes a jointly utilized memory, via which information is able to be exchanged between the numerical control and the machine-tool simulator. The jointly utilized memory is writeable and readable both by the numerical control and by the machine-tool simulator.

This may provide a very direct reading and writing access by a user or PLC programmer to the exchanged information via suitable display and input possibilities. The development of and troubleshooting in PLC programs may thereby be facilitated considerably.

Since many modern numerical controls are based on absolutely conventional industry computers (PCs) that are merely designed to be more robust and are expanded by interface cards, it may be possible to have the numerical control, the PLC and the machine-tool simulator executed on a single computer, which then may not have to have the interface cards mentioned, since the interface between the numerical control and the virtual machine tool is formed by the jointly utilized memory.

Thus, the necessary work may be performed very comfortably at a desk, and the expenditure of time and for devices may be considerably reduced.

According to an example embodiment of the present invention, an arrangement includes: a numerical control; a machine-tool simulator; and a device configured to exchange information between the machine-tool simulator and one of (a) the numerical control and (b) an allocated programmable logic controller, the device including a jointly utilized memory writeable and readable by the numerical control and the machine-tool simulator.

The jointly utilized memory may include a replica of all inputs and outputs of the programmable logic controller.

The jointly utilized memory may include a replica of operating data of at least one of (a) simulated position and velocity data of a virtual measuring system and (b) position and velocity setpoint values as setpoint selections of the numerical control at virtual axes.

The jointly utilized memory may be configured so that contents of the jointly utilized memory are writeable and readable directly by a user.

The machine-tool simulator may include a method interface configured to represent a machine control panel having elements that are linked to parts of the jointly utilized memory.

The arrangement may include an editable configuration data file configured to link elements of the machine control panel and the jointly utilized memory.

The method interface may be configured to program user-specific sequences of events by a high-level-language program.

The arrangement may include an axis simulator configured to reproduce behavior of virtual axes in accordance with data in the jointly utilized memory.

The axis simulator may be configured to simulate a lag error.

The jointly utilized memory may be arranged as a part of a main memory of a single computer, and the single computer may be configured to execute the numerical control with the allocated programmable logic controller and the machine-tool simulator.

The computer may be configured to display an operator interface of the numerical control and a machine control panel of the machine-tool simulator by windowing.

The arrangement may include a data file configured to permanently store at least a portion of contents of the jointly utilized memory and to write the stored portion into the jointly utilized memory as a starting value in accordance with switching on of the machine-tool simulator and the numerical control.

According to an example embodiment of the present invention, a device includes: numerical control means; machine-tool simulating means; and means for exchanging information between the machine-tool simulating means and one of (a) the numerical control means and (b) an allocated programmable logic controller means, the information exchanging means including jointly utilized memory means writeable and readable by the numerical control means and the machine-tool simulating means.

Further aspects of the present invention and details pertaining thereto are derived from the following description of an example embodiment with reference to the appended Figures.

### BRIEF DESCRIPTION OF THE DRAWINGS

FIG. 1 illustrates a numerical control with a machine-tool simulator.

FIG. 2 illustrates a virtual machine control panel having various elements.

FIG. 3 illustrates a display of the PLC outputs in the joint memory, via which the joint memory is able to be directly manipulated.

### DETAILED DESCRIPTION

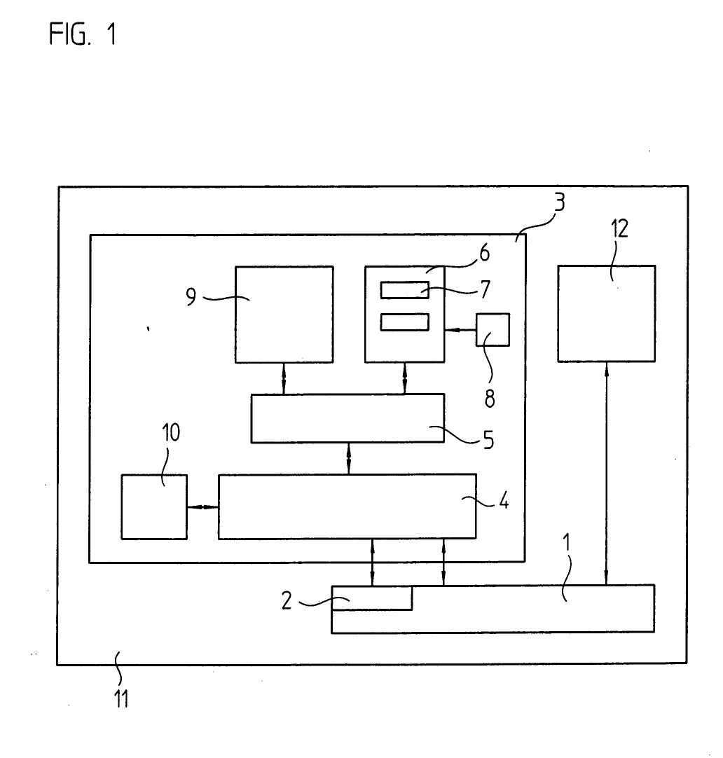

FIG. 1 illustrates a block diagram of a numerical control 1 with a machine-tool simulator 3. Numerical control 1 also includes a programmable logic controller, PLC 2 for short, which may be integrated into conventional numerical controls 1 using software technology. When an information exchange with numerical control 1 is discussed in the following, this definitely also means an information exchange with PLC 2. At the same time, the integration of PLC 2 into numerical control 1 is not a necessary prerequisite. This merely represents an example embodiment. Example embodiments of the present invention may also be used for systems in which numerical control 1 and PLC 2 are separate units.

In the exemplary embodiment described here, numerical control 1 is executed together with PLC 2 as a program on a computer 11. Operator interface 12 of numerical control 1 may be displayed in a separate window on the screen of computer 11. The operation of numerical control 1 via operator interface 12 corresponds completely to the operation in the case when numerical control 1 is connected to a real machine tool.

However, numerical control 1 does not communicate with a virtual machine tool as otherwise via one or more interface cards. Rather, numerical control 1 and PLC 2 access a jointly utilized memory 4. This jointly utilized memory 4 may be represented by a special area of the main memory of computer 11 which is arranged and reserved for this purpose.

Machine-tool simulator 3 may additionally be executed on the same computer 11 on which numerical control 1 and PLC 2 are also executed. The allocation of jointly utilized memory 4 to machine-tool simulator 3 in FIG. 1 is selected arbitrarily. This memory 4 may be represented as an independent area between numerical control 1 and machine-tool simulator 3.

Actual numerical control 1 stores, for example, position setpoint values or velocity setpoint values for the various axes of the virtual machine tool in memory 4. For example, these values may be predefined via operator interface 12 or a parts program running in numerical control 1.

Commands, for example, for the control of coolants, workholding palettes, tool changers, etc., are output by PLC 2 via its various outputs and written as information into memory 4. This information may include simple on/off information (binary memory values). However, memory 4 may also have information in the form of whole numbers (e.g., counter readings of position-measurement systems) or floating-point numbers (e.g., position of potentiometers for setting a factor (override), with which all velocities are multiplied to permit processes to execute faster or slower).

Connected to memory 4 is a method interface 5 which permits the basic accesses of the virtual machine tool to the various information and operating states contained in memory 4. For example, methods are available for reading the PLC outputs, for reading, setting and resetting the PLC inputs, for sending key codes in order to simulate user inputs, and for sending increments of a handwheel in order to simulate the operation of a handwheel, etc.

An axis simulator 10 calculates realistic actual position and velocity values based on the setpoint values predefined in memory 4 and other operating states. It is possible to simulate a following error or lag error with the aid control-engineering calculations, in order to make the simulation particularly realistic. The actual values thus obtained are made available in memory 4, for example, in the form of simulated encoder or button positions. A virtual measuring system may provide the simulated encoder positions.

For example, numerical control 1 reads out actual position and velocity values from memory 4, which were stored there by axis simulator 10. PLC 2 requests, via its inputs, widely varying operating states from memory 4. Thus, door contacts, emergency switches, temperature sensors or voltage monitors, etc., may be queried. The reaction of PLC 2 to these operating states is established in the PLC program, whose development may be as user-friendly as possible with the aid of an example embodiment of the present invention.

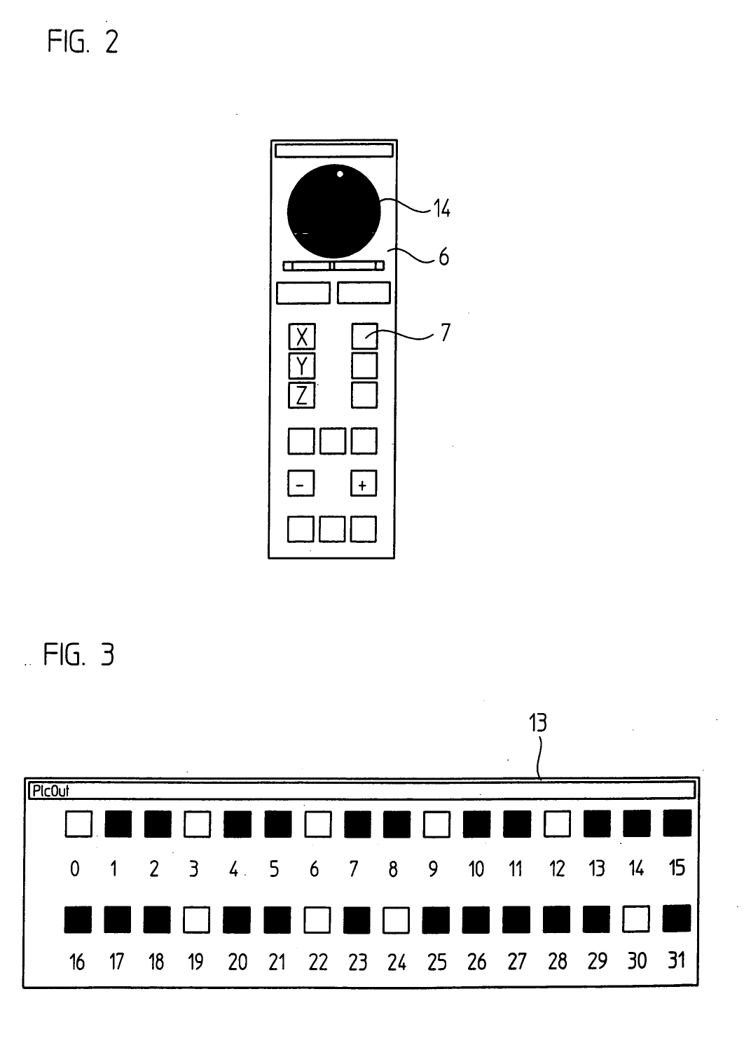

FIG. 2 illustrates a machine control panel 6 as represented by machine-tool simulator 3 via method interface 5 in a further window. Such machine control panels 6 replace the control panels present on the real machine tool. Various elements 7, which may be operated with the aid of a mouse or similar input device of computer 11, are used for the input. Thus, one element 7 may represent an emergency switch, another element 7 a key for the command “safely reduced velocity.”

FIG. 2 also illustrates a handwheel 14 which may be used to manually operate a machine tool.

To be able to flexibly design such a machine control panel 6 (a plurality of such control panels 6 may be used) and adapt it to the machine tool being simulated in each instance, the labels of individual elements 7, as well as their possibly repeated association with the inputs of PLC 2 or of numerical control 1, are set in a configuration data file 8 which the user is able to edit and modify. It is also possible to establish the properties of elements 7 more precisely, for example, whether a key is only intended to set an input for as long as it is pressed, or whether actuation of the key is supposed to permanently switch the input. The special wiring of the simulated machine tool may thus be replicated for the simulation by machine-tool simulator 3.

FIG. 3 illustrates a representation of the 31 outputs of PLC 2 in this example in a status window 13. The user may recognize at a glance which outputs are currently set (shown in dark) and which are not set (shown in light). A corresponding representation also permits a quick overview of the inputs of PLC 2. To be able to simulate any events as desired, a possibility is also provided to manipulate the contents of jointly utilized memory 4 directly. The inputs of PLC 2 may be switched by a mouse click on one of the light or dark fields in status window 13, to thus make it possible to check the reaction of PLC 2 or of the virtual machine tool. It may be provided that the outputs of PLC 2 may also be directly manipulated.

An example for a portion of a PLC program and its check test may look as follows: If the doors to the working area are open (the door switch, i.e., its virtual counterpart in memory 4 is at “open” at the PLC input—simulated by a corresponding input in status window 13 for the PLC inputs), all axes are to be blocked (mechanical holding brakes, i.e., their virtual counterpart in memory 4 are at “engaged” at the PLC output—to be checked in status window 13 of the PLC outputs) unless the key “safely reduced velocity” was pressed on machine control panel 6. In this case, for example, during setting-up operation, a slow movement of the axes with the doors open is supposed to be possible to permit precise observation of the processes.

Thus, the interplay of the virtual machine tool with numerical control 1 and its PLC 2 may be tested under very realistic conditions.

For more complex sequences, it may be tedious to implement the widely varying inputs via virtual machine control panel 6 or status windows 13. This may be true when an exact time sequence of the widely varying inputs is necessary during simulated operation of the virtual machine tool. Method interface 5 is therefore arranged so that an access to the simulated machine tool may be programmed via a high-level-language program 9. In this case, timers are also provided, so that any inputs or operations as desired are able to be executed automatically on the virtual machine tool. For example, using high-level-language program 9, it is possible to read and write the inputs and outputs of PLC 2, to manipulate the override, to simulate machine keys, to read out axis positions and to read and write measurement inputs. It may therefore be easier to test even complex sequences in the interaction of numerical control 1, PLC 2 and virtual machine tool or machine-tool simulator 3, until the performance of the PLC program is satisfactory.

For a portion of the data in jointly utilized memory 4, a battery backup may also be simulated which, when numerical control 1 and the machine tool are switched off in real systems, may ensure that certain data are retained until they are switched on again. To that end, the values that may be battery-backed in memory 4 are stored in a data file which, after machine-tool simulator 3 and numerical control 1 are switched on again, is read out and written again as a starting value into memory 4.

1. An arrangement, comprising:
a numerical control;
a machine-tool simulator; and
a device configured to exchange information between the machine-tool simulator and one of (a) the numerical control and (b) an allocated programmable logic controller, the device including a jointly utilized memory writeable and readable by the numerical control and the machine-tool simulator.

2. The arrangement according to claim 1, wherein the jointly utilized memory includes a replica of all inputs and outputs of the programmable logic controller.

3. The arrangement according to claim 2, wherein the jointly utilized memory includes a replica of operating data of at least one of (a) simulated position and velocity data of a virtual measuring system and (b) position and velocity setpoint values as setpoint selections of the numerical control at virtual axes.

4. The arrangement according to claim 1, wherein the jointly utilized memory is configured so that contents of the jointly utilized memory are writeable and readable directly by a user.

5. The arrangement according to claim 1, wherein the machine-tool simulator includes a method interface configured to represent a machine control panel having elements that are linked to parts of the jointly utilized memory.

6. The arrangement according to claim 5, further comprising an editable configuration data file configured to link elements of the machine control panel and the jointly utilized memory.

7. The arrangement according to claim 5, wherein the method interface is configured to program user-specific sequences of events by a high-level-language program.

8. The arrangement according to claim 1, further comprising an axis simulator configured to reproduce behavior of virtual axes in accordance with data in the jointly utilized memory.

9. The arrangement according to claim 8, wherein the axis simulator is configured to simulate a lag error.

10. The arrangement according to claim 1, wherein the jointly utilized memory is arranged as a part of a main memory of a single computer, the single computer configured to execute the numerical control with the allocated programmable logic controller and the machine-tool simulator.

11. The arrangement according to claim 10, wherein the computer is configured to display an operator interface of the numerical control and a machine control panel of the machine-tool simulator by windowing.

12. The arrangement according to claim 1, further comprising a data file configured to permanently store at least a portion of contents of the jointly utilized memory and to write the stored portion into the jointly utilized memory as a starting value in accordance with switching on of the machine-tool simulator and the numerical control.

13. A device, comprising:
numerical control means;
machine-tool simulating means; and
means for exchanging information between the machine-tool simulating means and one of (a) the numerical control means and (b) an allocated programmable logic controller means, the information exchanging means including jointly utilized memory means writeable and readable by the numerical control means and the machine-tool simulating means.
